(19) United States
(12) Patent Application Publication
(10) Pub. No.: US 2022/0173423 A1
(43) Pub. Date: Jun. 2, 2022

(54) FUEL CELL MODULE AND MANUFACTURING METHOD THEREOF

(71) Applicant: TOYOTA JIDOSHA KABUSHIKI KAISHA, Toyota-shi (JP)

(72) Inventor: Daisuke ISHIKAWA, Aichi-gun (JP)

(73) Assignee: TOYOTA JIDOSHA KABUSHIKI KAISHA, Toyota-shi (JP)

(21) Appl. No.: 17/450,555

(22) Filed: Oct. 11, 2021

(30) Foreign Application Priority Data
Nov. 30, 2020 (JP) 2020-198054

(51) Int. Cl. H01M 8/2475; H01M 8/2404

(52) U.S. Cl. CPC H01M 8/2475; H01M 8/2404

(57) ABSTRACT

A fuel cell module includes a fuel cell stack, a plurality of accessories configured to drive the fuel cell stack, and a frame to which the fuel cell stack and the accessories are fixed. The frame includes an upper frame and a lower frame connected to the upper frame. The fuel cell stack and at least one of the accessories are fixed to the lower frame such that the fuel cell stack and the at least one of the accessories are disposed on the lower frame. Remaining accessories are fixed to the upper frame such that the remaining accessories are suspended from the upper frame.

### CROSS-REFERENCE TO RELATED APPLICATION

This application claims priority to Japanese Patent Application No. 2020-198054 filed on Nov. 30, 2020, incorporated herein by reference in its entirety.

### BACKGROUND

### 1. Technical Field

The present disclosure relates to a fuel cell module and a manufacturing method for manufacturing a fuel cell module.

### 2. Description of Related Art

In the related art, as a fuel cell module of this type, Japanese Unexamined Patent Application Publication No. 2016-96064 (JP 2016-96064 A) describes, for example, a fuel cell module including a fuel cell stack, accessories configured to drive the fuel cell stack, and a case in which the fuel cell stack and the accessories are accommodated such that they are arranged side by side.

### SUMMARY

In the meantime, in the fuel cell module described in JP 2016-96064 A, the fuel cell stack and the accessories inside the case are attached to the case via support members such as brackets. However, in a case where the accessories are fixed in the up-down direction, accessories paced on the upper side are supported via support members from the lower side of the case. Such support members are provided in the fuel cell module by avoiding accessories placed on the lower side, so that the fuel cell module might be increased in size.

Further, at the time when the fuel cell module is assembled (manufactured), the accessories to be placed on the upper side cannot be placed until the accessories on the lower side and the support members are placed. Accordingly, the operation to arrange the accessories and the support members is complicated, so that some operators may require longer time to perform the operation.

In view of such a circumstance, the present disclosure provides a fuel cell module that can achieve downsizing of the fuel cell module even when a plurality of accessories is placed in the up-down direction. Further, the present disclosure provides a manufacturing method for manufacturing such a fuel cell module more easily.

In order to solve the above problem, a fuel cell module according to the present disclosure is a fuel cell module including a fuel cell stack, a plurality of accessories, and a frame. The accessories are configured to drive the fuel cell stack. The fuel cell stack and the accessories are fixed to the frame. The frame includes an upper frame and a lower frame connected to the upper frame. The fuel cell stack and at least one of the accessories are fixed to the lower frame such that the fuel cell stack and the at least one of the accessories are disposed on the lower frame. Remaining accessories among the accessories are fixed to the upper frame such that the remaining accessories are suspended from the upper frame.

In the present disclosure, the accessories are fixed separately to the upper frame and the lower frame, so that the accessories placed on the upper side among the accessories are fixed so as to be suspended from the upper frame. Accordingly, the accessories placed on the upper side do not need to be fixed by extending support members upward from the lower frame. On this account, even when the accessories are placed in the up-down direction, it is possible to downsize the fuel cell module.

Note that “a plurality of accessories” referred to in the present disclosure indicates accessories fixed directly or indirectly to the inside of the frame and does not indicate all accessories configured to drive the fuel cell stack. Accordingly, “remaining accessories” to be fixed to the upper frame as described in the present disclosure indicate remaining accessories that are not directly or indirectly fixed to the lower frame, among the accessories fixed directly or indirectly to the frame inside the frame.

Here, the upper frame and the lower frame may be adhered to each other or may be fixed to each other in the following aspect, for example. As a specific aspect, the upper frame and the lower frame may be detachably connected to each other via connecting members.

In this aspect, when the accessories are fixed separately to the lower frame and the upper frame in advance before the lower frame and the upper frame are connected to each other by the connecting members, all the accessories can be accommodated inside the frame at the time when the lower frame and the upper frame are connected to each other. As such, the accessories can be easily fixed. Further, at the time when the accessories are subjected to maintenance, the upper frame is removed from the lower frame by disassembling the upper frame from the lower frame. Hereby, it is possible to easily perform inspection, replacement, and so on of the accessories attached to the upper frame and the accessories attached to the lower frame.

Here, the configurations of the upper frame and the lower frame and a connecting position between the upper frame and the lower frame are not limited in particular, provided that the upper frame and the lower frame are detachably connected to each other. However, the following aspect may be employed, for example. As a specific aspect, the frame may be made of metal. The lower frame may include lower bracing portions extending horizontally and pillar portions extending vertically from the lower bracing portions. The upper frame may include upper bracing portions extending horizontally.

The lower bracing portions and the pillar portions may be fixed by welding. The pillar portions may be detachably connected to the upper frame via the connecting members.

In this aspect, the lower frame is configured such that the lower bracing portions and the pillar portions are fixed by welding. Accordingly, it is possible to secure the rigidity of the lower frame. Further, the upper frame is detachably connected to the pillar portions of the lower frame via the connecting members. Accordingly, after the remaining accessories are fixed to the upper frame, the upper bracing portions of the upper frame can be easily connected to the pillar portions of the lower frame. Further, at the time when the accessories are subjected to maintenance, it is possible to easily perform inspection, replacement, and so on of the accessories by disassembling the upper frame from the lower frame.

Further, the upper bracing portions constituting the upper frame and the lower bracing portions and the pillar portions constituting the lower frame can be constituted by square bars or the like, provided that the rigidity of the frame can be secured. However, the following aspect may be employed, for example. As a specific aspect, the fuel cell stack may be connected to the accessories by cables or pipes having flexibility. Each of the lower bracing portions, the upper bracing portions, and the pillar portions may have an L-shaped part having an L-shaped section in a direction perpendicular to a longitudinal direction of the each of the lower bracing portions, the upper bracing portions, and the pillar portions. A space formed by the L-shaped part may be formed as a part of an internal space of the frame. A corresponding one of the cables or the pipes may be disposed inside the space formed by the L-shaped part such that the corresponding one of the cables or the pipes makes contact with the L-shaped part.

In this aspect, at the time when the fuel cell stack is connected to each of the accessories by a cable or a pipe having flexibility, a part, of the cable or the pipe, that might protrude from the frame can be disposed so as to make contact with the L-shaped part so that the part fits into the space formed by the L-shaped part. Hereby, the cables and the pipes can be accommodated inside the internal space of the frame, so that it is possible to downsize the fuel cell module.

The present specification also describes a manufacturing method for manufacturing a fuel cell module according to the present disclosure. The manufacturing method according to the present disclosure is a manufacturing method for manufacturing a fuel cell module including a fuel cell stack, a plurality of accessories configured to drive the fuel cell stack, and a frame to which the fuel cell stack and the accessories are fixed. The frame includes an upper frame and a lower frame connected to the upper frame. The manufacturing method includes: a fixing step of, in a state where the upper frame is separated from the lower frame, fixing the fuel cell stack and at least one of the accessories to the lower frame such that the fuel cell stack and the at least one of the accessories are disposed on the lower frame, and fixing remining accessories among the accessories to the upper frame; and a connecting step of connecting the upper frame to the lower frame from above the lower frame such that the remaining accessories are suspended from the upper frame.

In the manufacturing method for manufacturing the fuel cell module configured as such, the fuel cell stack is fixed to the accessories in a state where the upper frame and the lower frame are separated from each other. More specifically, the fuel cell stack and at least one of the accessories are fixed to the lower frame, at respective positions where the fuel cell stack and the at least one of the accessories are disposed. The remaining accessories among the accessories are fixed to the upper frame, as respective positions where the remaining accessories are to be suspended. After that, the upper frame is connected to the lower frame. Accordingly, in comparison with a case where the fuel cell stack and the accessories are fixed to the frame after the frame is manufactured, it is possible to easily assemble the fuel cell stack and the accessories to the frame.

Here, at the time when the lower frame and the upper frame are connected to each other, they may be adhered to each other by welding or the like, and the connecting method is not limited in particular, provided that the lower frame and the upper frame can be connected to each other so as to be functionalized as one frame. However, the following aspect may be employed, for example. As a more specific aspect, the upper frame and the lower frame may be detachably connected to each other via connecting members. In the connecting step, the upper frame may be connected to the lower frame via the connecting members.

With this aspect, the upper frame can be easily connected to the lower frame via the connecting members. Further, at the time when the accessories are subjected to maintenance, the upper frame is removed from the lower frame by disassembling the upper frame from the lower frame. Hereby, it is possible to easily perform inspection, replacement, and so on of the accessories attached to the upper frame and the accessories attached to the lower frame.

Here, the configurations of the upper frame and the lower frame and a connecting position between the upper frame and the lower frame are not limited in particular, provided that the upper frame and the lower frame can be detachably connected to each other. However, the following aspect may be employed, for example. As a more specific aspect, the frame may be made of metal. The lower frame may include lower bracing portions extending horizontally and pillar portions extending vertically from the lower bracing portions. The upper frame may include upper bracing portions extending horizontally. The lower bracing portions and the pillar portions may be fixed by welding. In the connecting step, the pillar portions may be connected to the upper bracing portions via the connecting members.

In this aspect, the lower frame is configured such that the lower bracing portions and the pillar portions are fixed by welding. Accordingly, it is possible to secure the rigidity of the lower frame. Further, the upper frame is detachably connected to the pillar portions of the lower frame via the connecting members. Accordingly, after the remaining accessories are fixed to the upper frame, the upper bracing portions of the upper frame can be easily connected to the pillar portions of the lower frame. Further, at the time when the accessories are subjected to maintenance, it is possible to easily perform inspection, replacement, and so on of the accessories by disassembling the upper frame from the lower frame.

Further, the upper bracing portions constituting the upper frame and the lower bracing portions and the pillar portions constituting the lower frame can be constituted by square bars or the like, provided that the rigidity of the frame can be secured. However, the following aspect may be employed, for example. As a specific aspect, the fuel cell stack may be connected to the accessories by cables or pipes having flexibility after the fixing step and the connecting step. Each of the lower bracing portions, the upper bracing portions, and the pillar portions may have an L-shaped part having an L-shaped section in a direction perpendicular to a longitudinal direction of the each of the lower bracing portions, the upper bracing portions, and the pillar portions. A space formed by the L-shaped part may be formed as a part of an internal space of the frame. When the fuel cell stack is connected to the accessories, the cables or the pipes may be connected such that a corresponding one of the cables or the pipes is brought into contact with the L-shaped part inside a space formed by the L-shaped part.

In this aspect, at the time when the fuel cell stack is connected to each of the accessories by a cable or a pipe, a part, of the cable or the pipe, that might protrude from the frame is brought into contact with the L-shaped part so that the part fits into the space formed by the L-shaped part. Hereby, it is possible to downsize the fuel cell module.

With the fuel cell module of the present disclosure, even when a plurality of accessories is placed in the up-down direction, it is possible to downsize the fuel cell module. With the manufacturing method for manufacturing a fuel cell module according to the present disclosure, it is possible to more easily manufacture a fuel cell module in which a plurality of accessories is placed in the up-down direction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view of a fuel cell module according to the present embodiment;

FIG. 2 is a schematic system diagram of a fuel cell system constituting one embodiment of the fuel cell module according to the present embodiment;

FIG. 3 is an exploded perspective view in which a frame of the fuel cell module illustrated in FIG. 1 is disassembled;

FIG. 4 is a bottom plan view of the fuel cell module of the present embodiment;

FIG. 5 is a perspective view of a state where a plurality of accessories is fixed to an upper frame in the frame illustrated in FIG. 3 and a plurality of accessories is fixed to a lower frame;

FIG. 6A is a sectional view along a line A-A in FIG. 1;

FIG. 6B is a sectional view along a line B-B in FIG. 1; and

FIG. 7 is a flow diagram to describe a manufacturing method for manufacturing the fuel cell module illustrated in FIG. 1.

### DETAILED DESCRIPTION OF EMBODIMENTS

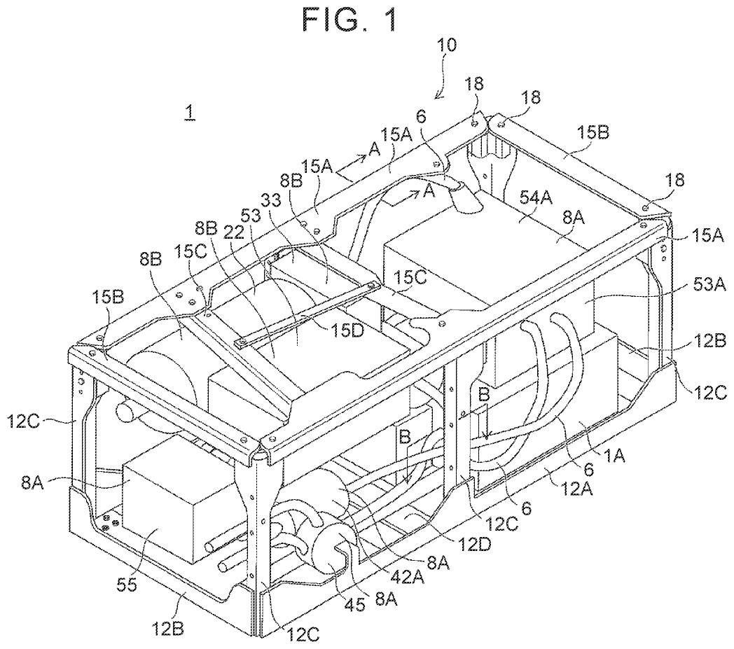

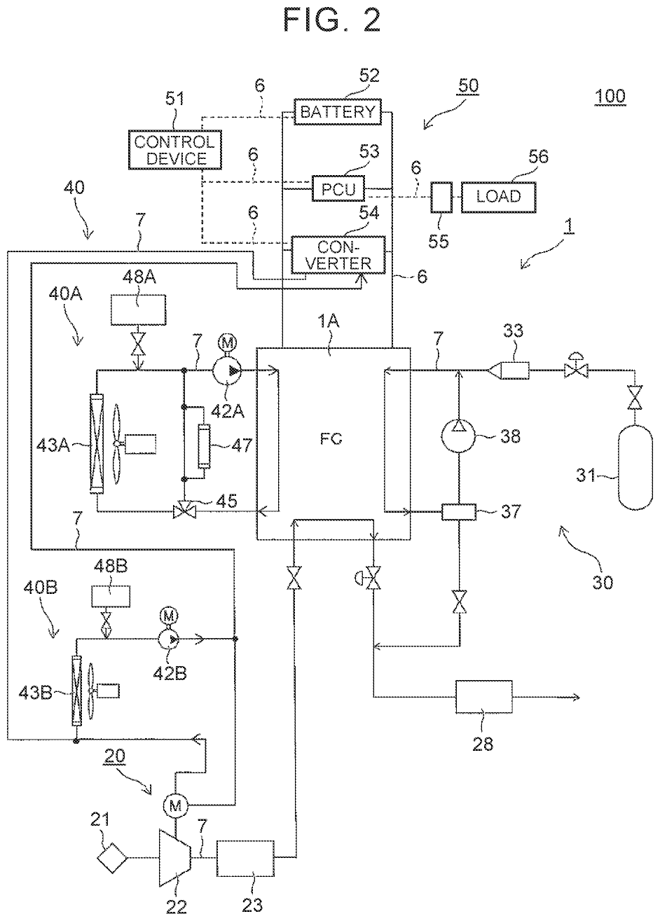

One embodiment of a fuel cell module according to the present disclosure will be hereinafter described in detail with reference to the drawings. As illustrated in FIG. 1, a fuel cell module 1 according to the present embodiment includes a fuel cell stack 1A, a plurality of accessories (described later) configured to drive the fuel cell stack 1A, and a frame 10 to which the fuel cell stack 1A and the accessories are fixed. The frame 10 will be described later. As illustrated in FIG. 2, a fuel cell system 100 is constituted by the fuel cell module 1, instruments such as a maintenance component, and other devices such as a hydrogen tank.

A fuel cell in the fuel cell stack 1A includes an electrolyte membrane having ionic permeability, and a membrane electrode assembly (MEA) constituted by an anode-side catalytic layer (an anode electrode) and a cathode-side catalytic layer (a cathode electrode) between which the electrolyte membrane is sandwiched. On either side of the MEA, a gas diffusion layer (GDL) configured to supply hydrogen gas as fuel gas or air as oxidant gas and to collect electric power generated by an electrochemical reaction is formed. The membrane electrode assembly on either side of which the GDL is placed is referred to as an MEGA, and the MEGA is sandwiched between separators provided in a pair. Here, the MEGA is a power generation portion of the fuel cell, and in a case where no gas diffusion layer is provided, the MEA serves as the power generation portion of the fuel cell.

The fuel cell stack 1A is connected to the accessories configured to drive the fuel cell stack 1A, and as illustrated in FIG. 2, the accessories constitute an air supply system 20, a hydrogen gas supply system 30, a cooling system 40, and a control system 50.

The air supply system 20 is configured to supply the air to the cathode electrode of the fuel cell constituting the fuel cell stack 1A and to discharge, from the fuel cell stack 1A, offgas subjected to an electrochemical reaction in the fuel cell. The air supply system 20 includes an air cleaner 21, a compressor 22, an inter cooler 23, and so on provided in this order from the upstream side from the fuel cell stack 1A, and the air supply system 20 also includes a muffler 28 and so on provided on the downstream side from the fuel cell stack 1A.

The air cleaner 21 removes dust in the air taken in from atmosphere. The compressor 22 compresses the air introduced via the air cleaner 21 and pumps the compressed air to the inter cooler 23. When the air pumped from the compressor 22 and introduced into the inter cooler 23 is passed through the inter cooler 23, the inter cooler 23 cools the air by heat exchange with refrigerant and supplies the air to the fuel cell stack 1A (the cathode electrode thereof), for example. In the fuel cell module 1 of the present embodiment, the compressor 22 and the inter cooler 23 are fixed to the frame 10 as the accessories of the fuel cell stack 1A.

The hydrogen gas supply system 30 is configured to supply hydrogen gas to the anode electrode of the fuel cell constituting the fuel cell stack 1A and to discharge, from the fuel cell stack 1A, offgas subjected to an electrochemical reaction in the fuel cell. The hydrogen gas supply system 30 includes a hydrogen gas source 31 and a hydrogen gas supply device 33 in this order from the upstream side from the fuel cell stack 1A, and the hydrogen gas supply system 30 also includes a gas-liquid separator 37 on the downstream side from the fuel cell stack 1A. The hydrogen gas supply system 30 includes a hydrogen gas pump 38 configured to circulate the hydrogen gas passing through the gas-liquid separator 37 to the upstream side.

The hydrogen gas supply device 33 includes an injector or the like configured to supply hydrogen gas to the fuel cell stack 1A. The gas-liquid separator 37 separates generated water included in the offgas. Hydrogen gas from which the generated water is separated is sent to the hydrogen gas pump 38, and the generated water is sent to the muffler 28. The hydrogen gas pump 38 pumps the hydrogen gas thus separated in the gas-liquid separator 37 and circulates the hydrogen gas to a fuel gas supply passage. In the fuel cell module 1 of the present embodiment, as the accessories of the fuel cell stack 1A, the hydrogen gas pump 38 and so on are provided in the frame 10.

The cooling system 40 is constituted by a main cooling system 40A configured to cool the fuel cell stack IA, a high-voltage instrument 54A (see FIG. 1) in which a converter 54 (described later) and so on are put together, and a sub-cooling system 40B configured to cool a motor or the like of the compressor 22.

The main cooling system 40A is a circulatory system. The main cooling system 40A is provided with a main pump 42A, a heat exchanger 43A, a three-way valve (rotary valve) 45, an ion exchanger 47, and a main tank 48A. The main pump 42A pumps refrigerant (coolant) cooled by the heat exchanger 43A to the fuel cell stack 1A. The heat exchanger 43A cools the refrigerant discharged from the fuel cell stack 1A. The ion exchanger 47 has a function to remove ions from the refrigerant that cools the fuel cell stack 1A, and the ion exchanger 47 is provided in a bypass passage. The three-way valve 45 introduces the refrigerant discharged from the fuel cell stack 1A into the heat exchanger 43A or the ion exchanger 47 in a divided manner. In the main tank 48A, refrigerant as a refill for the main cooling system 40A is stored, and when the refrigerant is insufficient, the refrigerant as a refill is supplied to the main cooling system 40A. In the present embodiment, as the accessories of the fuel cell stack 1A, the main pump 42A, the three-way valve 45, and so on are fixed to the frame 10.

The sub-cooling system 40B is provided with a heat exchanger 43B, a sub-pump 42B, and a sub-tank 48B. The sub-pump 42B pumps refrigerant (coolant) cooled by the heat exchanger 43B to the converter 54 and so on. The heat exchanger 43A cools the refrigerant discharged from the converter 54 and so on. In the sub-tank 48B, refrigerant as a refill for the sub-cooling system 40B is stored, and when the refrigerant is insufficient, the refrigerant as a refill is supplied to the sub-cooling system 40B. In the present embodiment, as the accessories of the fuel cell stack 1A, the sub-pump 42B and so on are fixed to the frame 10.

Various instruments (accessories and so on) in the air supply system 20, the hydrogen gas supply system 30, and the cooling system 40 are connected to each other via pipes 7 having flexibility. The flow rates, the pressures, and so on of fluid flowing through these members are controlled via valves. Note that, in FIG. 1, among a plurality of pipes, some pipes 7 are illustrated.

The control system 50 is configured to control driving and so on of the fuel cell stack 1A. The control system 50 is provided with a control device 51, a battery 52, a PCU 53, a converter 54, a junction box (relay box) 55, and a load 56. The control device 51 controls the valves and the power control unit (PCU) 53 (described later). Electric power generated in the fuel cell stack 1A is stored in the battery 52. The PCU 53 supplies electric power to the load 56 via the junction box 55 in response to the control by the control device 51. The converter 54 is included in the high-voltage instrument 54A (see FIG. 1) and boosts an output voltage from the fuel cell stack 1A and supplies it to the PCU 53. These accessories are electrically connected to each other via cables 6. Note that, in FIG. 1, among a plurality of cables, some cables 6 are illustrated.

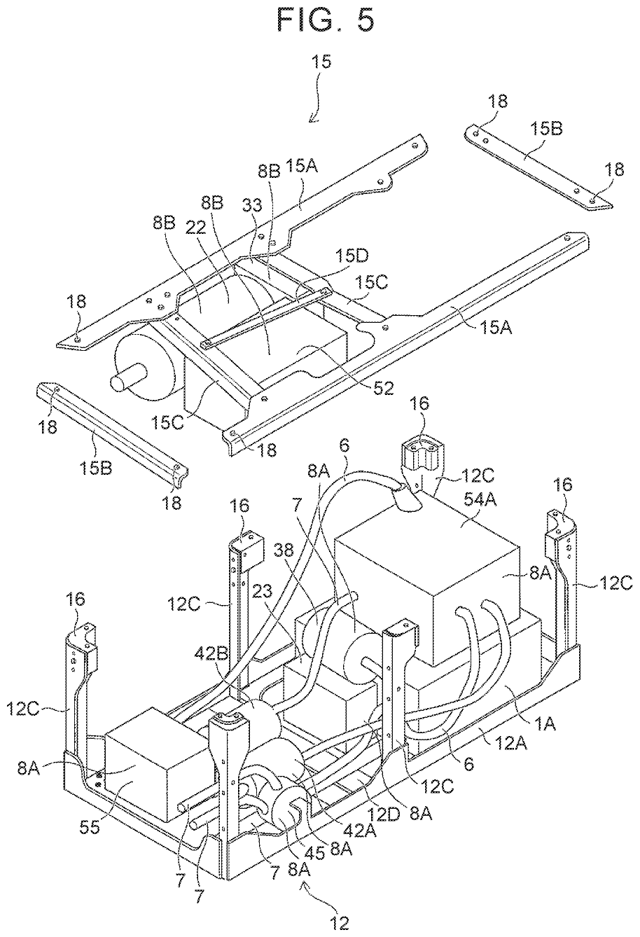

Here, in the present embodiment, as illustrated in FIGS. 1, 5, the fuel cell stack 1A and the accessories are fixed to the frame 10. The accessories fixed to the frame 10 include the compressor 22, the inter cooler 23, the hydrogen gas supply device 33, the hydrogen gas pump 38, the main pump 42A, the three-way valve 45, the sub-pump 42B, the PCU 53, the high-voltage instrument 54A, the junction box 55, and so on, as described above.

However, the accessories fixed to the frame 10 are not limited them, and the air cleaner 21, the heat exchangers 43A, 43B, other valves, and so on may be further fixed to the frame 10. In FIGS. 1, 5, among the accessories, a reference sign 8A is assigned to accessories fixed to a lower frame 12 (described later), and a reference sign 8B is assigned to accessories fixed to an upper frame 15.

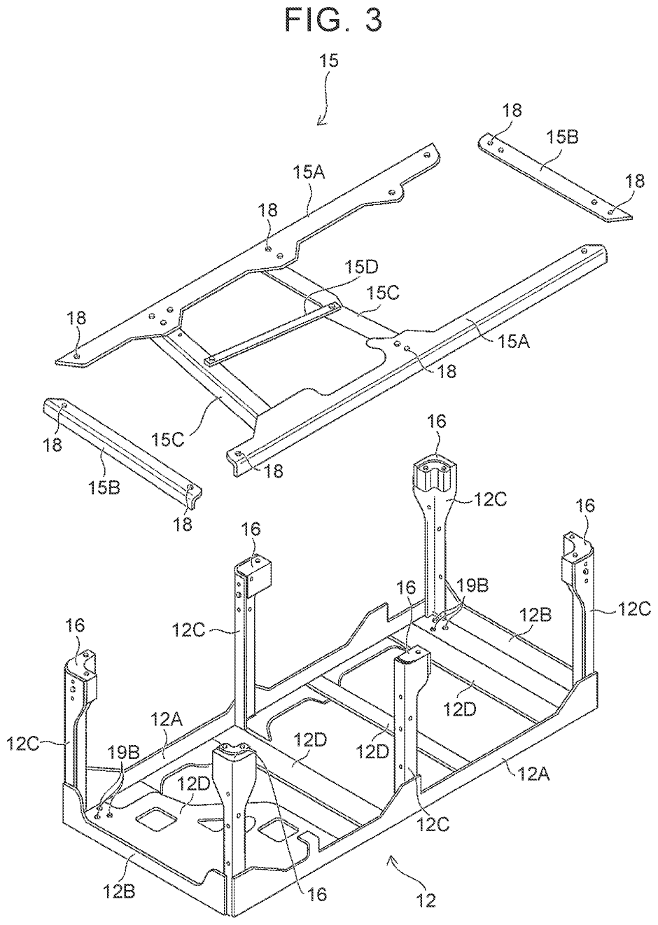

The accessories 8A, 8B constituting the fuel cell module 1 of the present embodiment are fixed to the frame 10 together with the fuel cell stack 1A. In FIG. 3, the frame 10 is basically made of a metal groove-shape steel material, an angle bar, a pipe material, or the like and includes the lower frame 12 and the upper frame 15. The upper frame 15 and the lower frame 12 are detachably connected to each other. More specifically, the frame 10 is made of metal. The upper frame 15 is detachably connected to an upper part of the lower frame 12 via brackets 16 and connecting members 18 such as connecting bolts.

The lower frame 12 constitutes a lower part of the frame 10, and the fuel cell stack 1A and the accessories 8A are fixed to the lower frame 12 such that the fuel cell stack 1A and the accessories 8A are disposed on the lower frame 12. Here, the accessories 8A include the inter cooler 23, the hydrogen gas pump 38, the main pump 42A, the three-way valve 45, the sub-pump 42B, the high-voltage instrument 54A, the junction box 55, and so on. Note that the high-voltage instrument 54A is indirectly fixed to the lower frame 12 via the fuel cell stack 1A.

The upper frame 15 constitutes an upper part of the frame 10, and remaining accessories 8B are fixed to the upper frame 15 in a suspended manner. Here, among the above accessories, the remaining accessories 8B are remaining accessories except for the accessories 8A provided on the lower frame 12 among the accessories fixed to the frame 10.

Here, the accessories 8B are fixed such that the compressor 22, the hydrogen gas supply device 33, and the PCU 53 are provided in a suspended manner.

As illustrated in FIG. 3, the lower frame 12 includes lower bracing portions 12A, 12B extending horizontally and pillar portions 12C extending vertically from the lower bracing portions 12A, 12B. The lower bracing portions 12A, 12b form a rectangular frame.

Among four sides of the outer periphery of the rectangular frame, the lower bracing portions 12A as long sides are joined to the lower bracing portions 12B as short sides by welding.

Further, a plurality of connecting portions 12D is fixed to the lower bracing portions 12A by welding or the like along the short-side direction of the lower frame 12 such that the lower bracing portions 12A as the long sides facing each other are connected to each other. Due to the connecting portions 12D, the lower frame 12 is fixed, and the fuel cell stack 1A and the accessories 8A are fixed to the lower frame 12 via brackets or the like.

As illustrated in FIG. 3, six pillar portions 12C extending vertically are provided at four corners of the lower frame 12 and at intermediate positions between the corners facing each other along the long sides such that the six pillar portions 12C are fixed to the lower bracing portions 12A, 12B by welding. Respective upper parts of the pillar portions 12C are formed to expand, and the brackets 16 via which the pillar portions 12C are connected to the upper frame 15 are fixed to the respective upper parts via bolts or the like. On respective top surfaces of the brackets 16, bolt holes to which the upper frame 15 are connected by connecting bolts are formed by drilling. The upper frame 15 and the lower frame 12 are detachably connected to each other via the connecting members 18 such as bolts.

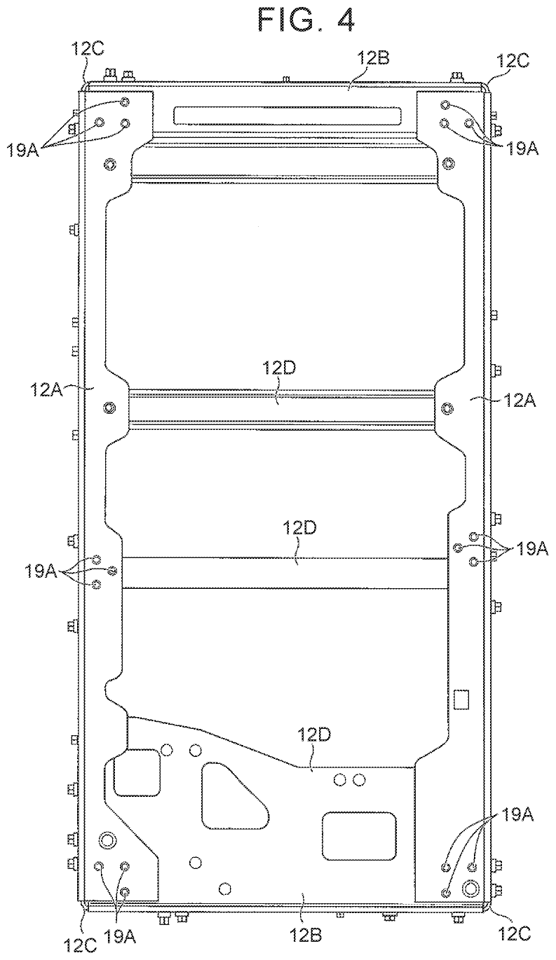

As illustrated in FIG. 4, a plurality of through-holes 19A via which the fuel cell module 1 is fixed by bolts is formed on a bottom surface of the lower frame 12. In the present embodiment, the through-holes 19A are provided at the four corners of the lower frame 12 and at the intermediate positions between the corners facing each other along the long sides. Nuts 19B (see FIG. 3) are adhered to upper parts, of the lower frame 12, where the through-holes 19A are formed. Hereby, when fixation bolts are passed through the through-holes 19A from an attachment portion (not illustrated) of a vehicle body or the like such that the fixation bolts are threadedly attached to the nuts 19B, the fuel cell module 1 can be fixed stably.

The upper frame 15 is formed to fit the shape of the lower frame 12 and includes upper bracing portions 15A, 15B extending horizontally. The upper bracing portions 15A, 15B form a rectangular frame. Among four sides of the outer periphery of the frame, the upper bracing portions 15A as long sides are connected to the upper bracing portions 15B as short sides by the connecting members 18 such as bolts via the brackets 16 attached to the pillar portions 12C of the lower frame 12. Note that the rectangular upper frame 15 may be formed by joining the upper bracing portion 15A, 15B to each other by welding.

Further, in the present embodiment, two intermediate beams 15C are connected to intermediate parts of the upper bracing portions 15A as upper hems in the long-side direction, and a reinforcement bar 15D is connected to the centers of the intermediate beams 15C in the longitudinal direction.

The lower bracing portions 12A, 12B, the upper bracing portions 15A, 15B, and the pillar portions 12C that form the frame 10 each have an L-shaped part having an L-shaped section in a direction perpendicular to the longitudinal direction thereof and are each made of an angle bar or the like. Note that the angle bar having an L-shaped part may be formed by welding two elongated plate materials along their longitudinal direction or may be formed by performing press molding on one elongated plate material along its longitudinal direction.

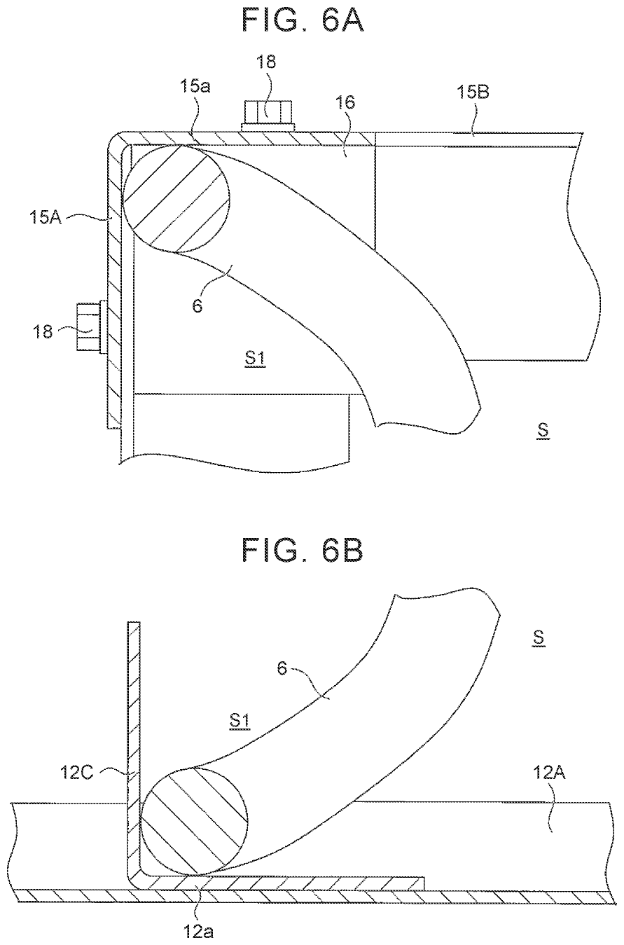

For example, as illustrated in FIGS. 6A, 6B, a space S1 formed by the L-shaped part of each of the lower bracing portions 12A, 12B, the upper bracing portions 15A, 15B, and the pillar portions 12C is formed as a part of an internal space S of the frame 10.

In other words, the L-shaped part formed along the longitudinal direction is opened inwardly inside the frame 10. For example, the L-shaped parts of the lower bracing portions 12A, 12B are opened upward inside the frame 10. Further, the L-shaped parts of the upper bracing portions 15A, 15B are opened downward inside the frame 10. The L-shaped parts can function as guide portions to receive the cables 6 and the pipes 7 inside the frame 10.

The upper frame 15 and the lower frame 12 of the frame 10 configured as such are connected to each other by the connecting members 18 such as bolts via the brackets 16 provided in the upper parts of the pillar portions 12C and also separable from each other by removing the connecting members 18.

Next will be described the fuel cell stack 1A and the accessories 8A, 8B fixed to the frame 10. As illustrated in FIG. 5, the fuel cell stack 1A is fixed to the lower frame 12 of the frame 10. More specifically, the fuel cell stack 1A is fixed by securing bolts or the like such that the fuel cell stack 1A is disposed over two connecting portions 12D in the short-side direction of the lower frame 12.

Further, among the accessories 8A, 8B, the inter cooler 23, the hydrogen gas pump 38, the high-voltage instrument 54A, the three-way valve 45, the main pump 42A, the sub-pump 42B, and the junction box 55 corresponding to the accessories 8A are fixed to the lower frame 12 by securing bolts or the like such that they are disposed on the lower frame 12. Among the accessories 8A, 8B, the compressor 22, the hydrogen gas supply device 33, and the PCU 53 corresponding to the accessories 8B are fixed to the upper frame 15 by securing bolts or the like in a suspended manner. The accessories 8A, 8B may be fixed to the frame 10 via brackets or the like. For example, some of the accessories 8A may be fixed indirectly to the lower frame 12 by fixing them to the fuel cell stack 1A or other accessories 8A fixed to the frame 10.

Inside the spaces S1 formed by respective L-shaped parts of the lower bracing portions 12A, 12B, the upper bracing portions 15A, 15B, and the pillar portions 12C, the cables 6 or the pipes 7 having flexibility are disposed so as to make contact with the L-shaped parts. For example, any of the cables 6 or the pipes 7 may be bundled with the L-shaped parts by bundling bands or the like.

As illustrated in the sectional view of FIG. 6A, an L-shaped part 15a is formed in the upper bracing portion 15A as the long side, and the space S1 formed by the L-shaped part 15a is opened toward the inside of the frame 10. In the present embodiment, inside the space S1 formed by the L-shaped part 15a, the cable 6 via which the high-voltage instrument 54A is connected to the junction box 55 is disposed so as to make contact with the L-shaped part 15a.

Further, as illustrated in the sectional view of FIG. 6B, an L-shaped part 12a is also formed in the pillar portion 12C placed in the intermediate part between the corners of the lower frame 12. The space S1 formed by the L-shaped part 12a is opened toward the inside of the frame 10. In the present embodiment, inside the space S1 formed by the L-shaped part 12a, the cable 6 via which the high-voltage instrument 54A is connected to the hydrogen gas pump 38 is disposed so as to make contact with the L-shaped part 12a.

In either case of FIGS. 6A, 6B, the cable 6 can be accommodated in the internal space S of the frame 10 such that a part, of the cable 6, that might protrude from the frame 10 fits into the space S1 formed by the L-shaped part 12a, 15a. This makes it possible to downsize the fuel cell module 1. Further, in FIGS. 6A, 6B, the cables 6 are brought into contact with the L-shaped parts 15a, 12a of the upper bracing portion 15A and the pillar portion 12C. However, the pipes 7 may be disposed so as to make contact with the L-shaped parts, or the cable 6 or the pipe 7 may be brought into contact with the L-shaped part 12a of the lower bracing portion 12A, for example.

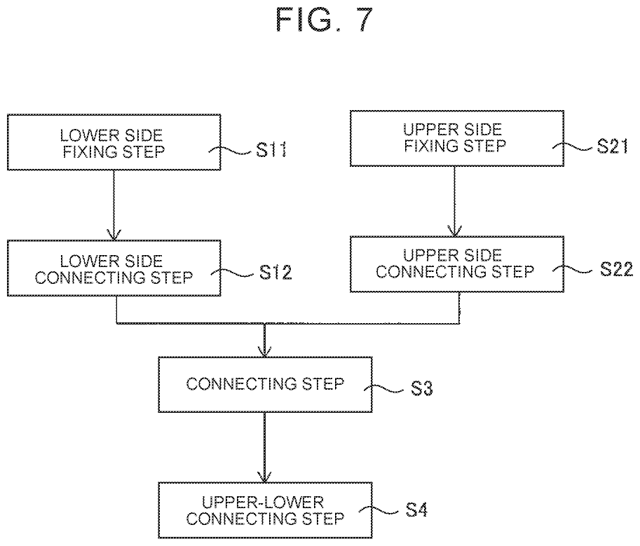

The following describes a method for manufacturing the fuel cell module 1 of the present embodiment with reference to FIG. 7. A lower side fixing step S11 and an upper side fixing step S21 are performed. More specifically, in a state where the upper frame 15 and the lower frame 12 are separated from each other, the lower side fixing step

S11 is performed such that the fuel cell stack 1A and the accessories 8A among the accessories 8A, 8B are fixed to the lower frame 12 such that the fuel cell stack 1A and the accessories 8A are disposed on the lower frame 12, and the upper side fixing step S21 is performed such that the remaining accessories 8B among the accessories 8A, 8B are fixed to the upper frame 15.

More specifically, in the lower side fixing step S11, the fuel cell stack 1A is fixed to the lower frame 12, and after that, the accessories 8A such as the hydrogen gas pump 38, the high-voltage instrument 54A, and the three-way valve 45 are fixed. In the upper side fixing step S21, the accessories 8B are fixed to a side where the accessories 8B are to be suspended. In the present embodiment, in a state where the upper bracing portions 15B as the short sides are removed from the upper frame 15, a main body of the upper frame 15 is assembled, and then, the accessories 8B such as the compressor 22, the hydrogen gas supply device 33, and the PCU 53 are fixed to the main body. Note that the lower side fixing step S11 and the upper side fixing step S21 may not be performed at the same time.

Subsequently, a lower side connecting step S12 and an upper side connecting step S22 are performed. These steps are performed as follows. In the lower side connecting step S12, the fuel cell stack 1A is connected to the accessories 8A by the cables 6 or the pipes 7 having flexibility, and the accessories 8A are connected to each other by the cables 6 or the pipes 7 having flexibility. In the upper side connecting step S22, the accessories 8B are connected to each other by the cables 6 or the pipes 7. At this time, as described with reference to FIG. 6B and so on, for example, the fuel cell stack 1A is connected to the accessories 8A, or the accessories 8A or the accessories 8B are connected to each other in a state where the cable 6 or the pipe 7 that may partially protrude from the space S of the frame 10 is brought into contact with its corresponding L-shaped part inside the space S1 formed by the corresponding L-shaped part. Note that the lower side connecting step S12 and the upper side connecting step S22 may not be performed at the same time. The upper side connecting step S22 may be performed after the lower side connecting step S12, and each connecting step may be performed after its corresponding fixing step.

Subsequently, a connecting step S3 is performed. In the connecting step S3, the upper frame 15 is connected to the lower frame 12 from above the lower frame 12 so that the accessories 8B are suspended from the upper frame 15. More specifically, the pillar portions 12C of the lower frame 12 are connected to the upper bracing portions 15A, 15B of the upper frame 15 by the connecting members 18 such as bolts. In the present embodiment, the main body of the upper frame 15 to which the accessories 8B are attached and the upper bracing portions 15B as the short sides are detachably attached to the pillar portions 12C of the lower frame 12.

Finally, after the connecting step S3, the fuel cell stack 1A and the accessories 8A fixed to the lower frame 12 and the accessories 8B fixed to the upper frame 15 are connected by the cables 6 or the pipes 7. At this time, as describe with reference to FIG. 6B and so on, they are connected in a state where the cables 6 or the pipes 7 connected in the lower frame 12 are brought into contact with the L-shaped parts 15a of the upper bracing portions 15A, 15B inside the spaces S1 formed by the L-shaped parts so that the cables 6 or the pipes 7 do not protrude from the space S of the frame 10.

Thus, in the present embodiment, the accessories are fixed separately to the upper frame 15 and the lower frame 12, so that the accessories 8B placed on the upper side among the accessories 8A, 8B are fixed so as to be suspended from the upper frame. Accordingly, the accessories 8B placed on the upper side do not need to be fixed by extending support members upward from the lower frame 12. On this account, even when the accessories 8A, 8B are placed in the up-down direction, it is possible to downsize the fuel cell module 1. Further, the accessories 8A, 8B can be individually fixed to the lower frame 12 and the upper frame 15, so that the fuel cell stack 1A and the accessories 8A, 8B can be assembled to the frame 10 easily in a short time.

Further, the upper frame 15 can be easily connected to the lower frame 12 via the connecting members 18. When the accessories 8A, 8B are subjected to maintenance, it is possible to easily perform inspection, replacement, and so on of the accessories 8B attached to the upper frame 15 and the accessories 8A attached to the lower frame 12 by removing the upper frame 15 from the lower frame 12 by disassembling the upper frame 15 from the lower frame 12.

One embodiment of the present disclosure has been described above in detail, but the present disclosure is not limited to the above embodiment, and various design modifications can be made without departing from the spirit of the disclosure described in Claims.

What is claimed is:

1. A fuel cell module comprising:
a fuel cell stack;
a plurality of accessories configured to drive the fuel cell stack; and
a frame to which the fuel cell stack and the accessories are fixed, wherein:
the frame includes an upper frame and a lower frame connected to the upper frame;
the fuel cell stack and at least one of the accessories are fixed to the lower frame such that the fuel cell stack and the at least one of the accessories are disposed on the lower frame; and
remaining accessories among the accessories are fixed to the upper frame such that the remaining accessories are suspended from the upper frame.

2. The fuel cell module according to claim 1, wherein the upper frame and the lower frame are detachably connected to each other via connecting members.

3. The fuel cell module according to claim 2, wherein:
the frame is made of metal;
the lower frame includes lower bracing portions extending horizontally and pillar portions extending vertically from the lower bracing portions;
the upper frame includes upper bracing portions extending horizontally;
the lower bracing portions and the pillar portions are fixed by welding; and
the pillar portions are detachably connected to the upper frame via the connecting members.

4. The fuel cell module according to claim 3, wherein:
the fuel cell stack is connected to the accessories by cables or pipes having flexibility;
each of the lower bracing portions, the upper bracing portions, and the pillar portions has an L-shaped part having an L-shaped section in a direction perpendicular to a longitudinal direction of the each of the lower bracing portions, the upper bracing portions, and the pillar portions;
a space formed by the L-shaped part is formed as a part of an internal space of the frame; and
a corresponding one of the cables or the pipes is disposed inside the space formed by the L-shaped part such that the corresponding one of the cables or the pipes makes contact with the L-shaped part.

5. A manufacturing method for manufacturing a fuel cell module including a fuel cell stack, a plurality of accessories configured to drive the fuel cell stack, and a frame to which the fuel cell stack and the accessories are fixed, the frame including an upper frame and a lower frame connected to the upper frame, the manufacturing method comprising:
a fixing step of, in a state where the upper frame is separated from the lower frame, fixing the fuel cell stack and at least one of the accessories to the lower frame such that the fuel cell stack and the at least one of the accessories are disposed on the lower frame, and fixing remining accessories among the accessories to the upper frame; and
a connecting step of connecting the upper frame to the lower frame from above the lower frame such that the remaining accessories are suspended from the upper frame.

6. The manufacturing method according to claim 5, wherein:
the upper frame and the lower frame are detachably connected to each other via connecting members; and
in the connecting step, the upper frame is connected to the lower frame via the connecting members.

7. The manufacturing method according to claim 6, wherein:
the frame is made of metal;
the lower frame includes lower bracing portions extending horizontally and pillar portions extending vertically from the lower bracing portions;
the upper frame includes upper bracing portions extending horizontally;
the lower bracing portions and the pillar portions are fixed by welding; and
in the connecting step, the pillar portions are connected to the upper frame via the connecting members.

8. The manufacturing method according to claim 7, wherein:
the fuel cell stack is connected to the accessories by cables or pipes having flexibility after the fixing step and the connecting step;
each of the lower bracing portions, the upper bracing portions, and the pillar portions has an L-shaped part having an L-shaped section in a direction perpendicular to a longitudinal direction of the each of the lower bracing portions, the upper bracing portions, and the pillar portions;
a space formed by the L-shaped part is formed as a part of an internal space of the frame; and
when the fuel cell stack is connected to the accessories, the cables or the pipes are connected such that a corresponding one of the cables or the pipes is brought into contact with the L-shaped part inside a space formed by the L-shaped part.
